(19) United States
(12) Patent Application Publication
(10) Pub. No.: US 2002/0032603 A1
(43) Pub. Date: Mar. 14, 2002

(54) Method for promoting internet web sites

(76) Inventor: John O. Yeiser, Alpine, CA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 09/848,490

(22) Filed: May 3, 2001

Related U.S. Application Data
(60) Provisional application No. 60/201,636, filed on May 3, 2000.
(60) Provisional application No. 60/273,033, filed on Mar. 2, 2001.

(51) Int. Cl. G06F 17/60

(52) U.S. Cl. 705/14

(57) ABSTRACT

The method for advertising Internet web sites comprises purchasing a block of air time from a media provider such as a television channel or web provider, producing a media segment to be shown during that air time for displaying on the screen of a communication device a combination of two or more of a scrolling list of web site addresses, graphical banners and video clips of a host who talks about a featured service, product or web site. A web site proprietor may select any one or combination of several advertising options. Additional interest in a client's web site is generated by providing a video which is produced and maintained by the advertising service provider and providing a hyperlink at the client's web site for accessing and playing the video.

### RELATED APPLICATIONS

This application claims the benefit of priority to U.S. provisional applications Ser. No. 60/201,636, filed May 3, 2000, and Ser. No. 60/273,033, filed Mar. 1, 2001.

### FIELD OF THE INVENTION

The invention relates to a method for advertising Internet web sites. More specifically, selling, producing, and distributing media segments over a communication network for advertising Internet web sites for display on a communication device.

### BACKGROUND OF THE INVENTION

The Internet is a large, interconnected network of computer networks linking computers all over the world through the use of the phone lines, satellites, and other telecommunications systems. The Internet was originally developed as a research network in the early 1970's to provide scientists and researchers with better communication and data exchange. In the early 1990's, the World Wide Web (WWW) was made available by the creation of an Internet web browser called Mosaic. Mosaic was an instant success because for the first time it allowed computer users to see the Internet through an easy to use graphical interface that displayed web pages incorporating text, graphics, sound, animation, and other multimedia elements.

The WWW quickly became a success, and companies began to realize that the medium was perfect for targeting consumers and an excellent way to dispense information for a small expense. Most companies now have a web site, which has an associated host network address referred to as a “URL” or a “domain name.”

When a domain name is typed in the computer, the network translates the alpha characters into numeric characters. These characters are considered to be a location on the Internet because they point to a specific location, a web site. Every web page has its own web site, which is its address, similar to a telephone number or street address. In practice, a domain name forms part of the Uniform Resource Locator (URL), the complete electronic address for a web site. For example, a domain name might be “yourcompany.com”, but the entire URL will have the form: “http://www.yourcompany.com.” To access a web site, a computer user types the domain name into the location bar of the web browser and initiates a search. Once the web site is found, it then appears in the web browser available for interactive input. The term “domain name” is often used to communicate the location of a web site on the WWW. Most web browsers allow computer users to simply enter the domain name in the location bar rather than the entire URL as discussed above, making access to the web site even easier.

Since the Internet is a global network, many businesses have domain names. Advertising these domain names can be a problem when there are millions of competing businesses, large and small, vying for the same advertising space. Search engines are the most common way of indexing domain names so that potential customers can find a company's web site. On-line advertising through hypertext links, banner advertisements, email, co-ops, and other related methods is another way of gaining exposure for the web site. For a small business with limited resources, the cost of advertising a domain name can be prohibitively expensive because everyone is competing for limited space on the most popular search engines and web sites.

Even though the Internet is extremely popular and relatively inexpensive, television is still the most popular and effective medium for advertising. Even limited exposure on television can be more effective at reaching a broad audience than a major Internet advertising campaign. Web television reinforces this because the advertising campaign is still directed to the television audience. Although businesses may now display a single web site address during a television media segment, i.e., a commercial, advertising services or products, the costs of production of the advertisement and purchasing the air time are relatively high. This acts to exclude smaller businesses which lack substantial advertising budgets. Thus, there is currently no medium in existence which provides access to a television audience for increasing traffic to a web site without requiring the business proprietor to incur significant costs in production and purchasing air time.

While the Internet has provided a medium for inexpensive advertising that is accessible to virtually anyone, generally only those businesses with larger advertising budgets are able to build web sites that are interesting and interactive in a way that attracts visitors, both first time and repeat, to carefully review the content of the web site. One way of making web sites more interesting is to include streaming video, a compressed signal that allows transmission of a raw video signal containing color, detail, and sound. Because the large amount of data contained in a raw video signal can consume a significant amount of bandwidth, the signal is encoded, then decoded, using a compression algorithm that is typically included in a media player. Due to limitations imposed by data compression and the need for very high playout rates to multiple Internet users who might be simultaneously accessing the video, special considerations are required in the production of the videos as well as the transmission of the streaming videos. For distribution, a streaming server, which is separate from the web server, is required to handle the high playout rates. The resources for production and distribution of streaming video are not always available to the average web site owner, so that only a relatively small number of web sites have streaming video features.

The need remains for one or more methods for increasing traffic to web sites that is cost effective and readily accessible to businesses of all sizes.

### SUMMARY OF THE INVENTION

It is an advantage of the present invention to provide a method of advertising Internet web sites through the use of scrolling text, graphical banners, and talking hosts.

It is a further advantage of the present invention to provide a method of advertising Internet web sites by selling, producing, and distributing media segments which include scrolling web site addresses, a talking host, and other related information.

Another advantage of the present invention is to provide a method of advertising Internet web sites where the media segments are targeted to specific advertising markets.

Yet another advantage of the present invention is to provide a method of advertising Internet web sites through the use of television, either conventional television or interactive television.

Another advantage of the present invention is to provide a method of promoting Internet web sites and/or products/services advertised on Internet web sites by producing and providing access via the Internet to streaming video.

It is a further advantage of the present invention to provide a method for promoting Internet web sites and/or products/services advertised on Internet web sites by providing a streaming video that is linked to the advertiser's web site.

In an exemplary embodiment, the method for advertising Internet web sites comprises purchasing a block of air time on a television channel, producing a media segment to be shown during that air time for displaying on the television screen a combination of a scrolling list of web site addresses, graphical banners and video clips of a host who talks about a featured service, product or web site. Each of the web site addresses in the scrolling list can be accompanied by a brief, one line description of the web site content or services/products. The addresses are preferably categorized according to content or services. The banner advertisement may include the client's logo or artwork showing the client's products, along with contact information. The video clip can show the host promoting specific web sites with information such as a product demonstration, public relations information or marketing news.

The web site addresses, banners and video clips that are displayed during the media segment are for clients, e.g., businesses, who have purchased an advertising spot on the media segment. The client may purchase any one or combination of several advertising options, from display of their web site address within the scrolling list of addresses to a packaged combination including the web site listing, banner ad, a promotional pitch on video by the media segment host, a link on the operator's web site, search engine placement, or any other option that is designed to increase traffic to the client's web site. The cost of the advertising will depend on the number of selected advertising options. The television channel can be either a broadcast network or a cable channel.

In an alternate embodiment, either in place of, or in addition to, displaying the web sites on a television program, the scrolling list of web site addresses, banner advertisements and/or video clips are displayed on the Internet by accessing the advertising service provider's web site. The web site addresses contained in the scrolling list and banner ads are displayed as hyperlinks to the client's web site. Similarly, if the program is viewed on interactive WebTV® or a similar interactive television service, access to the advertised web site can be obtained via a hyperlink shown on the television screen.

In another embodiment, advertising services offered to the client include a streaming video of a promotional pitch, interview, or product demonstration which is produced by the advertising service provider. Access to the streaming video is provided via a hyperlink, such as a button that says “Video Demo”, or “As Seen on IPRETV™” which is placed on the client's web site. The link accesses the service provider's Internet web site (e.g., www.ipretv.com) where the encoded data for the streaming video, i.e., the streaming server and audio/video packets, resides and can be accessed for viewing via an appropriate media player plug-in at the web site visitor's computer. In an alternative embodiment, the video can be downloaded to the web site visitor's computer, again by accessing the service provider's web site via a link from the client's web site. The transition from the client's web site to the service provider' web site should be rapid, so that to the web site visitor, the video appears to have been directly accessed from the client's web site. Alternatively, or in addition to the link on the client's web site, the link to the video can also be provided on the service provider's Internet web site. Because the streaming server is accessible only through the service providers' web site, the service provider maintains control over the video and enables the additional service of monitoring hits on the video to provide helpful feedback to the client whose product or service is being advertised. In addition or in the alternative, by monitoring hits on a streaming video advertising a particular client's product or services, the service provider can provide a payment arrangement that is directly related to the benefit received by the client. By charging on a “per hit” basis, the clients who receive the most benefit from the service will pay more, while those clients whose product videos do not generate a significant traffic increase will not pay more than a minimal base fee. Because the service provider maintains control over the video, it is able to choose to continue showing the video if the client renews its advertising subscription or discontinue access to the video if the client fails to renew.

### BRIEF DESCRIPTION OF THE DRAWINGS

Understanding of the present invention will be facilitated by consideration of the following detailed description of an exemplary embodiment of the present invention taken in conjunction with the accompanying drawings, in which like numerals refer to like parts and in which:

FIG. 1 is a block diagram of an exemplary method of the system of the present invention;

FIG. 2 is a system block diagram showing the interconnection of several example embodiments of a plurality of media providers, the communication network, and a plurality of communication devices of the present invention;

FIG. 3 is a screen shot of an exemplary embodiment of a media segment as display on a communication device of the present invention;

FIG. 4 is a flowchart of an exemplary method of the present invention showing the steps of sending a media segment from a media provider over the communication network to a user to be viewed on a communication device;

FIG. 5 is a block diagram of an exemplary method of the present invention showing the steps of a user accessing a web site to register for a membership number along with other available options; and

FIG. 6 is a flowchart of an exemplary method of the present invention showing the steps of a user accessing a web site to place an order for a media segment spot.

### DETAILED DESCRIPTION OF THE PREFERRED EMBODIMENTS

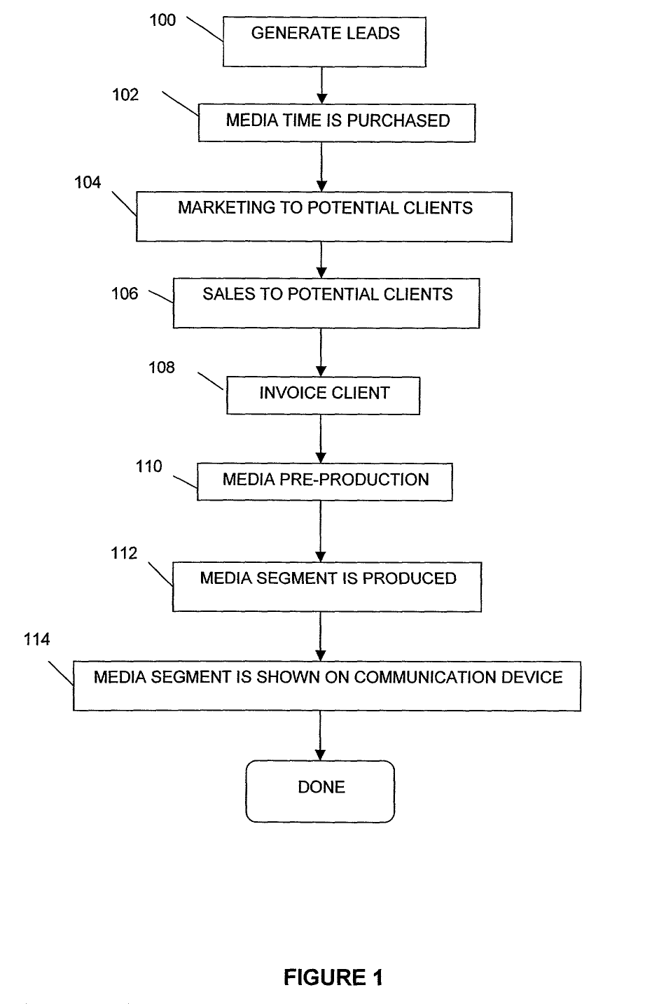

FIG. 1 is a block diagram of an exemplary embodiment of the method of the present invention. At step 100, the advertising service provider (ASP) generates leads for potential clients. Leads can be obtained in any manner that will provide information regarding a potential client. For purposes of the methods described herein, a potential client can be any web-based business or service, including informational or entertainment web sites that do not generate revenue from sales or subscriptions, or a business that maintains an Internet web site for promotional purposes or for conducting e-commerce. “Potential clients” or “clients” may also be referred to herein as “web site proprietors.” Any potential lead can be valuable since a web based business can be easily started from in the home to a major corporation.

The ASP can obtain leads for potential clients by buying lists of names, addresses, telephone numbers, mobile phone numbers, pager numbers, fax numbers, email addresses, web site addresses, and similar related combinations. Additionally, leads can be acquired through trade publications or searching the WWW. Leads can be purchased from a variety of different providers such as list management companies, credit reporting agencies (CRAs), Dun & Bradstreet, Internet Service Providers (ISPs), Domain name registrars, e-commerce companies, and similar related providers. Leads can also be obtained by purchasing access to on-line databases that the aforementioned providers have implemented. Such on-line databases can be proprietary dial-in databases or accessible through the Internet.

The lead can be any entity, individual or business that is involved in e-commerce, has an established web-based business, or maintains an Internet web site for promotional purposes or conducting e-commerce, i.e., a web site proprietor. Once leads are obtained by the ASP, the leads are entered into a lead database. The leads can be entered into the database manually or in an automated procedure where the database receives electronic updates. The leads are then accessible by ASP representatives for contacting the potential clients in an effort to generate orders. The leads can then be manipulated to create reports or sent electronically to other departments within the ASP, e.g., accounting or marketing, for processing.

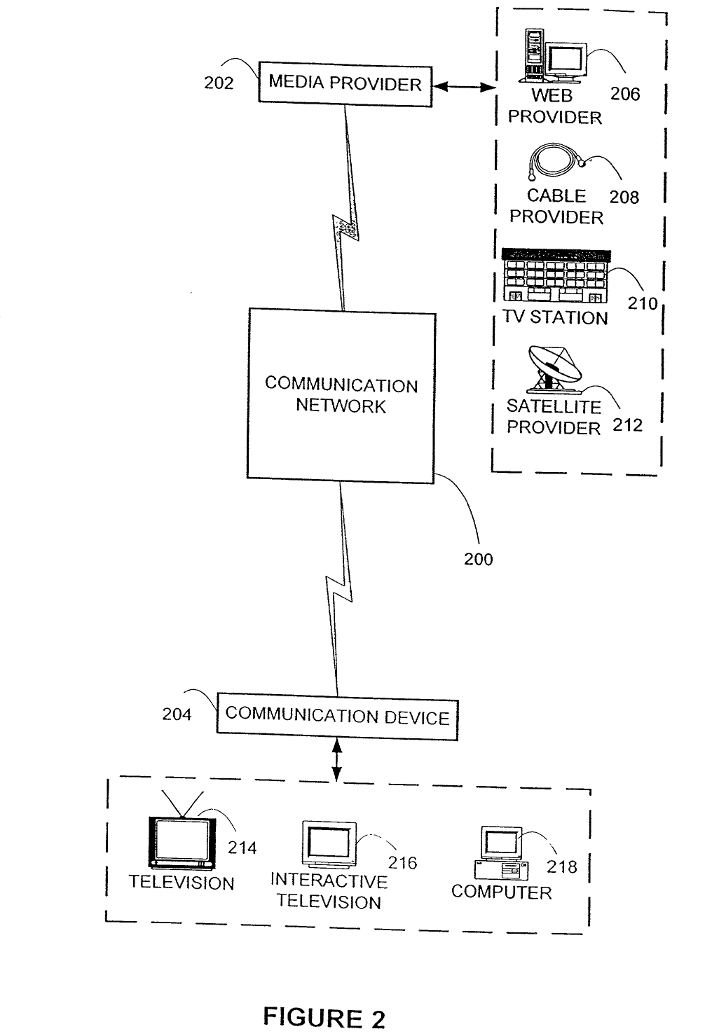

At step 102, media time is purchased for airing each media segment. The ASP contracts with a plurality of media buyers to purchase “air time” from media providers such as web providers 206, cable providers 208, television (TV) stations 210, and satellite providers 212, as shown in FIG. 2. The media time acquired for airing of a media segment can be purchased by submitting a request for whatever air dates and times the media provider might have available. Once the available media time is confirmed, the air dates and times for each media segment is entered into the ASP's database and made available on the ASP's web site for access by ASP representatives and potential clients.

At step 104, marketing to potential clients is performed. ASP representatives, referred to as “Account Executives” or “Sales Associates”, access the ASP's lead database and initiates contact with those leads. The ASP representatives will typically contact potential clients by telephone, making cold calls, however, other communication methods may be used including direct mail, electronic mail (email), facsimile (fax), or via web site postings or banner advertisements, or any other appropriate method of disseminating information about the ASP's service. For making cold calls, ASP representatives will preferably use a scripted sales pitch in an attempt to convince the potential client of the benefits to their business provided by the ASP's service and to solicit an order for one or more services.

As an alternative to the telephone solicitations, sales literature can be sent to a potential client by, e.g., contracting with Internet marketing companies who specialize in targeted email services. For example, the email messages will consist of brief descriptions of the company's services and present opportunities prompting the potential client to link to the ASP web site or use a toll free number to speak with an ASP representative. The ASP can market its services in any available manner, preferably directed to the market for the service, including, in addition to the methods stated above, by advertisements in publications targeted to web site proprietors and designers, ISPs, radio and television commercials, informational commercials (infomercials), and any other appropriate method of disseminating information.

At step 106, once a potential client decides to purchase a media segment package the ASP representative can process the order. Alternatively, a potential client can place an order directly by telephone, fax, email, computer, web site, or similar related means.

Clients will be offered different media segment packages. These media segment packages can include any combination of associated ASP services. In one example implementation, broadcast packages and web site packages can be offered to the client. Broadcast packages are geared towards a client who wants advertising in the media segment, whereas a web site package is focused towards a client wanting to advertise only on the ASP's web site. A broadcast package can include a media segment spot, a web site scroll, a banner ad on the media segment, a promotional pitch by the media segment host, and similar related options. Web site packages can include a banner ad on the ASP's web site, a link on the ASP's web site, search engine placement, and similar related options. Selected variations on the broadcast packages and web site packages can be combined to meet a client's specific preference.

In another exemplary implementation, “value packages” or “value packs” can be used to entice potential clients to place an order. Value packages can be divided into international packages, domestic packages, local packages, global packages, and similar related packages. Value packages can include a media segment spot, a web site scroll, a banner ad on the media segment, a banner ad on the ASP's web site, a promotional pitch by the media segment host, a link on the ASP's web site, search engine placement, and similar related options.

International packages are targeted toward clients that require advertising exposure in one or more countries outside of the U.S. The international package would be tailored for the client's needs, and could include any city, state or province, or groups thereof, within a given country, a country, or groups of countries in which exposure was desired. Some examples include Japanese national broadcasts, Canadian national broadcasts, International affiliates, Pan European broadcasts, and Brazilian broadcasts.

Domestic packages are available for clients that prefer to target a national market. The national market can include any or all major national broadcasting channels or cable networks such as ABC, NBC®, CNBC®, USA®, MSNBC®, TNN®, FOX®, FoxNet®, Speedvision®, Odyssey®, and similar channels. The national market can also include special interest channels such as The Auto Channel®, The Travel Channel®, The Pet Channel®, Finance Channel®, HGTV®, Home & Garden Channel®, Court TV®, SciFi Channel®, Outdoor Life Channel®, The Learning Channel®, ESPN®, Fox Sports West®, and other similar dedicated channels. The purchase of media time on one of the special interest channels allows the ASP to make available to its client a more directed advertising approach to a market that will more likely have interest for the client's web site, products and/or services. For example, media segments shown on The Auto Channel® could feature web sites, products and/or services applicable to cars.

Local packages are available for clients that require advertising exposure in a local market, which is preferable for the client whose business is generally patronized by local area residents, e.g., locally owned restaurants, medical clinics, home repair contractors, etc. A local market can be a county- or city-based broadcast area, and viewers can be reached through programming on local network or cable stations and community access cable programming. For example, coverage for Los Angeles would include all local broadcast stations that can be viewed within the Los Angeles area.

Global packages are targeted for client requiring advertising exposure both within and outside the U.S. The global market includes a combination of all the markets discussed above including the international markets, domestic markets, and local markets. The value packages are not limited to any specific combination and can incorporate additional options not discussed above.

The ASP representative will preferably complete the client's order over the telephone. The ASP representative can direct the client to make the order on the ASP web site or any other order process as discussed above. In one example implementation, the ASP sales representative completes the client's order over the telephone by taking appropriate sales and billing information including name, address, payment information, media segment spot script, media segment air dates and times, web site address and brief description, and other related information. The media segment spot script includes the information that the media segment host will incorporate in making a promotional pitch about the client's web site, if the host option is selected. Appropriate information for the spot script includes the interesting features of the client's web site and the products and/or services that are shown or offered on the web site, which information the ASP representative can obtain from the client.

The ASP representative can have the option of having the client pay over the telephone via credit card or by an invoice. The ASP representative will confirm all sales and billing information with an emphasis on the correctness of the media segment spot script, and media segment air dates and times. Once the client has confirmed the information, the ASP sales representative will provide information about invoicing.

At step 108, an invoice is sent to the client after a order has been completed. The invoice can contain confirming information including contact information, billing information, media segment spot script, media segment spot air dates and times, banner advertisement rotation, banner advertisement placement, category placement, web site scroll information, and various statistical information regarding the rotation of the web site address scroll and banner advertisement. The invoice can provide for the client to submit payment of the order if the client had not paid at the time of the order was placed. The invoice can be delivered by traditional mail, fax, email, web site, or any appropriate method.

At step 110, the media pre-production process is performed. Media pre-production is the detailed planning process for a media segment. A media segment is a produced advertising program that can be seen by a viewer via a communication device 204. The media segment can be any length of time but will preferably be 30 minutes in length. In one embodiment, the media segment could be continuously running on a dedicated 24 hour channel. A dedicated 24 hour channel would preferably have multimedia segments to fill the time period.

The media segment can be arranged or displayed in any layout. The media pre-production process can be used for production of a media segment for display by traditional television programming and/or Internet-based programming as shown in FIG. 2.

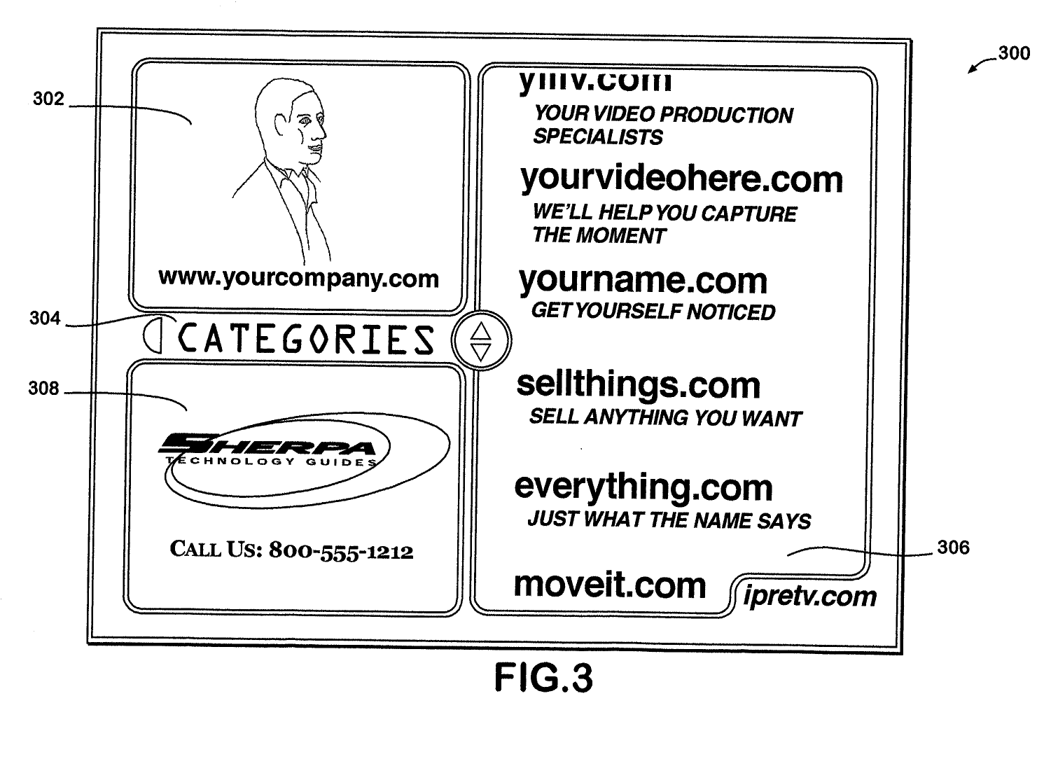

The exemplary embodiment of a media segment as displayed on a communication device is shown in FIG. 3 as display screen 300. The media segment will be a combination of different messages and formats for displaying messages. In the preferred embodiment, the display screen will preferably be divided into three main sections: a host section 302, a web site scroll section 306, including a category indicator 304, and a banner advertisement section 308.

The host section 302 can be presented in any format that will provide for entertainment to a viewer watching the media segment. For example, a human host, virtual host, cartoon host, music group, or any other form of host can be used. In the preferred embodiment, a video will preferably depict a human host talking about any subject relevant to the ASP's web site or a web site advertised thereon. For example, the host could feature a specific client whose web site is advertised on the media segment if the web site's proprietor has paid additional fees for a featured spot. Generally the host's comments will be scripted, with the script provided by the client or prepared by the ASP. Multiple clients can be featured during any given media segment, with each feature being on the order of 30 seconds or a minute. In between the features, the host can make brief comments, which may also be scripted, about other web sites advertised in the scrolling list, for example “visit petstore.com for all of your pet's needs.” The host section 302 will typically be in a conventional video format prepared in accordance with NTSC (National Television Standards Committee) standards or, where available, HDTV (high-definition television) standards. Alternatively, traditional commercial advertising can be used in the host section 302. For example, a client can provide a pre-existing or specially-produced commercial to be played during a time segment for which it has paid fees. For display on the Internet via a web site, the host section will preferably be in a streaming video format. In the latter case, the amount of activity on the screen will preferably be minimized in order to avoid blurring of the image that frequently occurs as a result of the compression of the signal.

The category indicator 304 is used to notify the viewer of the particular category of web site addresses that will appear in the web site scroll section 306. Any topic or category can appear in category indicator. The web site addresses will preferably be divided up into categories, and in some cases, a single web site addresses may be displayed within multiple categories. In an example implementation, the word “Automotive” would appear in the category scroll indicator 304 to notify the viewer that they are viewing web site addresses geared towards the automotive area. This same web site address might also be displayed under the category of “Hobbies.” In one embodiment, a media segment viewed on an interactive television 216 or through the ASP's web site will permit the viewer to select and view a particular category.

The web site scroll section 306 is used to scroll web site addresses with a brief description, generally one line, of the web site's content. The web site addresses and descriptive information can be scrolled in any manner. For example, the web site addresses and related information can be scrolled upward or downward, or the screen can simply display a group of addresses for a fixed period of time, then switch to another screen after the period is over. The speed of the scroll will preferably be at a rate that will allow an average viewer to see and remember a web site address and related information. In an embodiment where the media segment is viewed on an interactive television 216 or through a web site, controls can be provided to allow the viewer to adjust the speed and direction of the scrolling web site addresses.

The displayed web site addresses can be in the form of a full Uniform Resource Locator (URL). In the example “http://www. yourcompany.com/about.html”, the URL begins with the characters “http” for “Hypertext Transfer Protocol.” The colon and back slashes are delimiters that distinguish between protocol designators and the address. The “www” (World Wide Web) is the host name and “Yourcompany” is the second level domain name with the “.com” being the top level domain name. The “about.html” is an HTML web page that is accessible through a web browser when the entire URL is requested. Alternatively, the displayed web site addresses can be in the form of a domain name. A domain name is generally perceived as the location of an Internet web site, however, the URL is the actual complete electronic address for an Internet web site. For simplicity, and because it is easier to remember, the preference is to use the domain name. Most viewers and computer users are accustomed to seeing domain names and understand how to access a web site using the associated domain name through the WWW.

The web site addresses will be shown and organized according to their related category. Each web site address can be listed along with additional description information regarding the web site. For example, the web site for a client, e.g., “Yourcompany,” can have its web site address “Yourcompany.com” displayed in the web site scroll section 306 along with a line of text describing the web site located below the web site address, as shown in FIG. 3.

The banner advertisement section 308 can have any format which will display information. For example, a banner advertisement can be in the form of text, graphical images, icons, animated images, static or dynamic banners, talking images, web pages, web sites, and any similar related forms. The banner advertisement section 308 will preferably have a combination of text and graphical images. For example, a graphical banner for a business would appear showing the client's business name and logo along with the associated telephone number in text below the banner image. A similar example can be seen in the banner advertisement section 308. It should be noted that not all formats or sections need be present during any given program, i.e., host, scrolling and banner sections, and any single message format, or any combination of formats, can be used in the media segment.

In an alternate embodiment, in order to further increase traffic to the client's web site by making the web site more interesting, and to further promote the client's products or services, the ASP can offer an optional additional service consisting of a streaming video with audio showing a promotional pitch, interview, testimonial, or product demonstration which is accessible through the client's web site. The video is produced by the ASP, relieving the client of the burdens of production of the video, supporting a separate streaming server, and incorporating the necessary programming code into the web site to permit accessing and viewing of the video. Specifically, the ASP maintains a streaming server that appears to the viewer to be accessed directly from the client's web page via a hyperlink to the URL of the compressed audio/video. In actuality, in view of the need for commands and address information to access and activate the streaming video, the link from the client's web site is to the ASP's web site which provides the link to the streaming server. By directing access to the video through the ASP's web site, the ASP has the ability to monitor and/or count the number of Internet users who accessed the client's video or to obtain other visitor information using features programmed into the ASP's web site. A link for accessing the video can also be provided at the ASP's web site, which allows visitors to the ASP's web site to directly access the client's video. The hyperlink display on the ASP's web site can feature the client's name, logo, product name or other identifying information, thus providing the client additional exposure for their advertising to an Internet user who might not otherwise have thought to look for the client or their product.

The video features audio and video components which can draw the web site visitor's attention to a salient feature of the client's web site, products or services. For current streaming video technologies, the video will feature a minimal amount of motion to avoid blurring. Generally, production of the video consists of a camera in a fixed position focused on an individual who is seated or standing in one location in a studio. For example, the host can be seated at a desk or table with the featured product in his or her hand, so that motion is limited to hand movements to provide different views allowing key features of the product to be pointed out. The host can be, for example, an actor or celebrity hired by the ASP, or can be a spokesperson selected by the client. The script for the video As larger bandwidths or higher data rate transmissions become more widely available, the need to restrict the video subject to minimal motion will become less important.

Access to the streaming video is provided via a link, such as a button that says “Video Demo”, or “As Seen on IPRETV™” which appears on the client's web site. The link accesses the ASP's Internet web site (e.g., www.ipretv.com) which then provides a link for accessing a streaming server which is separate from the web server that operates the ASP's web site. The streaming server contains and operates the encoded data packets for the streaming video along with the control commands for managing the playout process. The video can be accessed for viewing via an appropriate video player plug-in at the web site visitor's computer. The streaming server begins transmission of a stream of data packets containing the video to a playout buffer in the visitor's computer, where, once a portion of the data is received, it can begin playing while the rest of the video is being transmitted and decompressed. In an alternative embodiment, the video can be downloaded in its entirety to a playout buffer in the web site visitor's computer before any playout begins, which may be advantageous for Internet users with slow modems and/or slow Internet connections. Again, the web site visitor accesses the advertising service provider's web site via a link from the client's web site. The transition from the client's web site to the ASP's web site should be rapid and seamless, so that, to the web site visitor, the video appears to have been directly accessed from the client's web site. In addition or as an alternative to placing a hyperlink at the client's web site, a link to the streaming video can be provided at the ASP's web site. At the ASP's web site, the hyperlink would appear as a button with the client's name, logo, product name, or some other identifying feature. Inclusion of the link at the ASP's web site allows the client to attract the interest of a visitor to the ASP's web site who might otherwise not have been looking for the client or the client's products or services, but seeing the button, took advantage of the opportunity to view the video.

Because the video is maintained at the service providers' web site, the service provider maintains control over the video and enables the additional service of monitoring hits on the video to provide helpful feedback to the client whose product or service is being advertised. By monitoring hits on a particular client's video, the ASP can also structure advertising fees on a “per hit” basis, so that clients will be charged in proportion to the exposure they receive. Thus, those who benefit most will pay more while those who do not attract a significant number of viewers will not pay much more that a minimum base fee, which generally will cover the production costs for making the video. Also, because the service provider maintains control over the video accessible only through its streaming server, it is able to choose to continue showing the video if the client renews its advertising subscription or discontinue access for playing the video if the client fails to renew. Because the ASP produces the video and maintains the streaming server, the client is not required to arrange for and expend its own time for production or maintenance but is still able to obtain the benefits of making his or her web site more interesting to Internet users by including a video. The more interesting web site increases traffic to the web site and provides greater exposure for the services or products offered through the web site.

Generally, the pre-production process for the media segment starts with copies of the invoices from step 108 being delivered to a production coordinator. The production coordinator works with the producer to plan every element of the media segment. The producer will review the invoices, which contain complete details of the ordered media segment packages. By reviewing the invoices, the producer will be able to create a media segment plan. The media segment plan will include every detail of the media segment from the beginning to the end including media segment length, host script, web site address creation and placement, banner advertisement placement, and other related details. The producer uses the media segment plan to assign various tasks to the pre-production department. For example, the graphic artists will be assigned the tasks of creation and placement of the text for the web site addresses and graphical images and text for the banner advertisements. The producer is also generally responsible for finding a director and a host for each media segment and provides the appropriate information to the director and host. The host can be work from a prepared host script or may be asked to prepare his or her own host script based on all the media segment spot scripts supplied by the clients. Using the supplied information, the host can tailor the host script to each particular client's key selling features. Alternatively, the producer can have a script writer create a prepared host script.

At step 112, the media segment is produced. Production of the media segment is controlled by the director. The director is in charge of all aspects of shooting and editing the media segment. The media segment can be taped at any location but will preferably be taped at a television studio. Alternatively, a dedicated 24 hour channel format could be used where all the media segments would be broadcast in realtime, often referred to as “live” broadcasts. The host segment is shot and edited into the media segment. All media segment elements are assembled in post production editing. A master of the show is produced and a sub-master is sent to the ASP's sub-contracted tape duplication house. An electronic version of the media segment is sent to a web producer to be integrated into the web site.

At step 114, the media segment is shown on a communication device as shown in FIG. 3. The media segment can be broadcast by a web provider 206, cable provider 208, TV station 210, satellite provider 212, or other similar providers as shown in FIG. 2.

The media segments can be broadcast in the international market, national market, local market, or a combination of all three. The international market includes any broadcast stations not broadcast in the United States. For example, Japanese broadcasts, Canadian broadcasts, International affiliates, Pan European broadcasts, and Brazilian broadcasts. The national market includes all major national broadcasting channels or cable networks such as ABC®, NBC®, CNBC®, USA®, MSNBC®, CNN®, FOX®, FoxNet®, Speedvision®, Odyssey®, and similar channels. The national market can also include special interest channels such as The Auto Channel®, The Travel Channel®, The Pet Channel®, Finance Channel®, HGTV®, Home & Garden Channel®, Court TV®, SciFi Channel®, Outdoor Life Channel®, The Learning Channel®, ESPN®, Fox Sports West®, and other similar dedicated channels. The local market can include channels that are based within a county or city.

The ASP can alternatively establish its own 24 hour television network. One benefit of having an exclusive 24 hour network is that advertising can be done in the traditional manner with small advertising intervals within a media segment. Alternatively, a leased dedicated 24 hour channel can be used where media segment time is purchased in incremental time intervals.

FIG. 2 is a system block diagram showing the interconnection of several example embodiments of a plurality of media providers 202, a communication network 200, and a plurality of communication devices 204 of the present invention.

Media providers 202 are the starting point for the broadcasting of a media segment. A media provider 202 can be any provider that can transmit a media segment over the communication network 200 to be received and displayed on a communication device 204. For example, a media provider 204 can be a web provider 206, cable provider 208, TV station 210, satellite provider 212, or similar related provider. A web provider 206 has the necessary equipment and resources to transmit a media segment over the Internet. The web provider 206 can transmit the media segment in any manner that would allow a viewer to view the media segment on a communication device. For example, the web provider could transmit the media segment as “streaming video” or static video. Streaming video would allow a viewer to view the media segment as a “live broadcast” or in a more efficient manner. The web provider 206 can also provide a web site located on the WWW that would provide access to the media segments for viewers. The media segments can be in the form of files when accessed in through a web site.

The communication network 200 can be any network that allows the sending and receiving of data. In an example embodiment, the communication network 200 would be a wireless based system such as satellite, terrestrial, cellular, GSM (Global System for Mobile communication), PCS (Personal Communications Services), PDC (Personal Digital Cellular), microwave, infrared, or radio communications network. The wireless-based systems as discussed above would preferably use the Wireless Application Protocol (WAP). WAP is a specification for a set of communication protocols to standardize the way that wireless communication devices can be used for Internet access, including the World Wide Web (WWW). The benefit of using WAP is that communication devices 204 and service systems can interoperate.

In another example embodiment, the communications network 200 would be a non-wireless based system such as cable, digital cable, WebTV®, ISDN (Integrated Services Digital Network), DSL (Digital Subscriber Line), xDSL (i.e., ADSL, HDSL, RADSL), Internet Cable (i.e., cable modems), PPP (Point-to-Point Protocol) connections over telephone lines or network connections, or direct network based connections. Selection and incorporation of such a communication network will be apparent to those of skill in the art.

In another example embodiment, the communication network 200 is the Internet. The Internet is a global network of computers referred to as “servers” which are accessible by communication devices 204, often referred to as user nodes or client computers. These communication devices 204 typically access the Internet through a provider called an Internet Service Provider (ISP) or through a direct Internet connection. The media provider 202 in this embodiment would be a web provider 206. The web provider 206 would use a server system to transmit a media segment over Internet. The server system has a unique Internet Protocol (IP) address on the Internet. Each computer on the Internet, referred to as a host has at least one address that uniquely identifies it from all other computers on the Internet.

The server system is located on the WWW at a host network address specified by a predetermined URL. The resource accessed via the URL can be any file supported by HTTP, for example, a web page, CGI application, Java® application, image file, document file, text file, or any similar related file types. The streaming server for use with streaming video options preferably uses UDP (user datagram protocol) with real time transport protocol (RTP) to avoid transmission delays that are introduced by the HTTP/TCP used for the standard web server.

The server system includes a hardware system and a software system. The hardware system can be any computer system with different configurations and architectures. The hardware system will preferably include a display, keyboard, CPU (Central Processing Unit), memory, I/O controller, disk controller, non-volatile storage devices (e.g., hard drive, floppy drive, optical drive, tape backups), and the ability to interface to the communication network. Selection and incorporation of such a server hardware system will be apparent to those of skill in the art.

The communication device 204 is used to receive and display a media segment to a viewer. The communication device 204 can be any device that allows for information to be received and/or sent over a communication network 200. In an exemplary embodiment, the broadly identified communication device 204 can be any device or a combination of devices illustrated in the lower box (dashed lines) of FIG. 2, including television 214, interactive television (WebTV®) 216, and a computer 218, which may include a networked computer, laptop, or handheld computer (e.g., Personal Digital Assistant (PDA)). Other possibilities for the communication device 204 include mobile phone (e.g., cellular phone, digital phone), video phone, pager, and any other similar devices.

WebTV® allows users to browse the Internet through an interactive television 216 and watch media segments simultaneously. The interactive television 216 can be provided in the form of a standard television combined with separate interactive equipment or a television with integrated (pre-installed) interactive equipment. The interactive equipment will generally include a set-top box, a television and/or cable connection, a modem, a remote control, a mouse, a keyboard, a printer, and other related equipment. The set-top box has connectors for television and/or cable services along with connectors to a modem and telephone line.

The implementation of the invention is not dependent on any particular device and can be implemented in various configurations and architectures.

The communication device 204 will preferably include a graphical user interface (GUI) which can be any program that allows a media segment to be displayed. For example, a proprietary software program or, preferably, an Internet web browser, can be used.

User interface with the communication device 204 can occur by manual manipulation, voice communication, thought process mechanisms, or any other method of interaction. Manual manipulation includes operation of a touch screen, keyboard, keypad, pointing device, mouse, light pen, remote control or shortcut buttons. Voice communication is provided by a voice recognition system which can be incorporated into or added to the communication device. Such systems are known in the art. Thought process mechanisms could be incorporated into the communication device 204 to allow hands-free entry. Neural attachments could be secured to the user's head so that muscle movements could be translated by the communication device 204 allowing the user to automatically his or her selection on the graphical user interface.

In one example implementation, the communication network 200 is a cable network. In this example, the media provider 202 is a cable provider 208, while the communication device is a television 214. The cable provider 208 transmits the media segment over a channel on the communication network 200 to be displayed on the television 214. The television 214, tuned to the appropriate channel, displays the media segment as shown in FIG. 3 display screen 300.

In another example implementation, the communication network 200 is a WebTV® network, i.e., the Internet. In this example, the media provider 202 is a web provider 206, while the communication device 204 is an interactive television (WebTV®) 216. The web provider 206 transmits the media segment from a server system over communication network 200 for displays on the interactive television 216. The interactive television 216 receives and displays the media segment from the web provider 206 as shown in FIG. 3 display screen 300.

The interactive television 216 provides the viewer interactive options, including the ability to access the Internet so that a viewer can access related advertised Internet web sites while watching television. In the interactive embodiment, the display screen 300 shown in FIG. 3 will be completely interactive for the viewer. The viewer can select a scrolling web site address or a banner advertisement and will be immediately taken to the associated web site. The viewer can view web sites and the display screen 300 simultaneously.

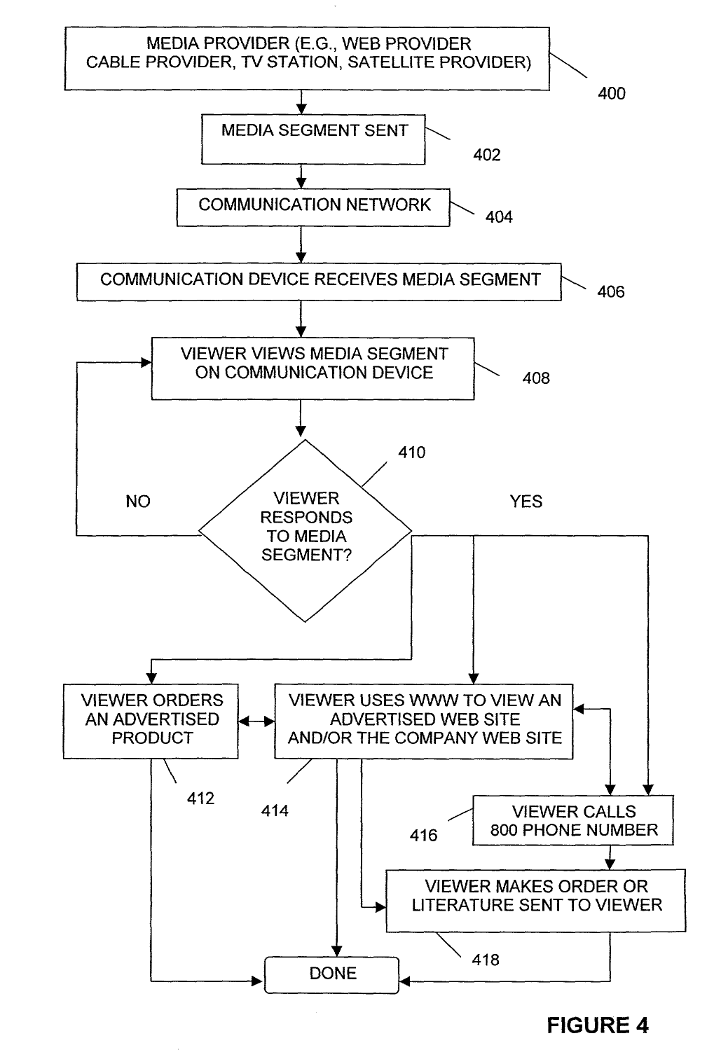

FIG. 4 is a flowchart of an exemplary method of the present invention showing the steps of sending a media segment from a media provider 202 over the communication network 200 to a user to be viewed on a communication device 204 as shown in FIG. 2.

At step 400, a media provider 202 prepares all necessary equipment to broadcast the media segment and transmits a media segment at step 402. At step 404, the media segment is transmitted, over the communication network 200 to a communication device 204. For purposes of the method described herein, “transmit” includes any method of conducting, transferring, broadcasting, communicating or otherwise conveying a programming signal which can be converted and displayed on a communication device. The communication device 204 receives the media segment at step 406. At step 408, a viewer watches the media segment on a communication device 408 and can “respond” to the media segment advertising to find out more about a product 412, or order the product, by using the WWW to view the advertised web site of interest and/or to access the ASP web site 414 which provides a link to the advertised web site. Alternatively, the viewer can call the ASP's 800 telephone number 416. If the viewer does not wish to “respond” he or she can continue to view the media segment in step 408.

At step 412, for a preferred, interactive embodiment, the viewer can order a product, or obtain more information, using an interactive television 216 or computer 218 by moving a cursor on the display screen to the image of the product and selecting, e.g, “clicking”, the product using the input device. After steps 414 and 416, the viewer can make an order or request associated literature to be sent to the viewer 418.

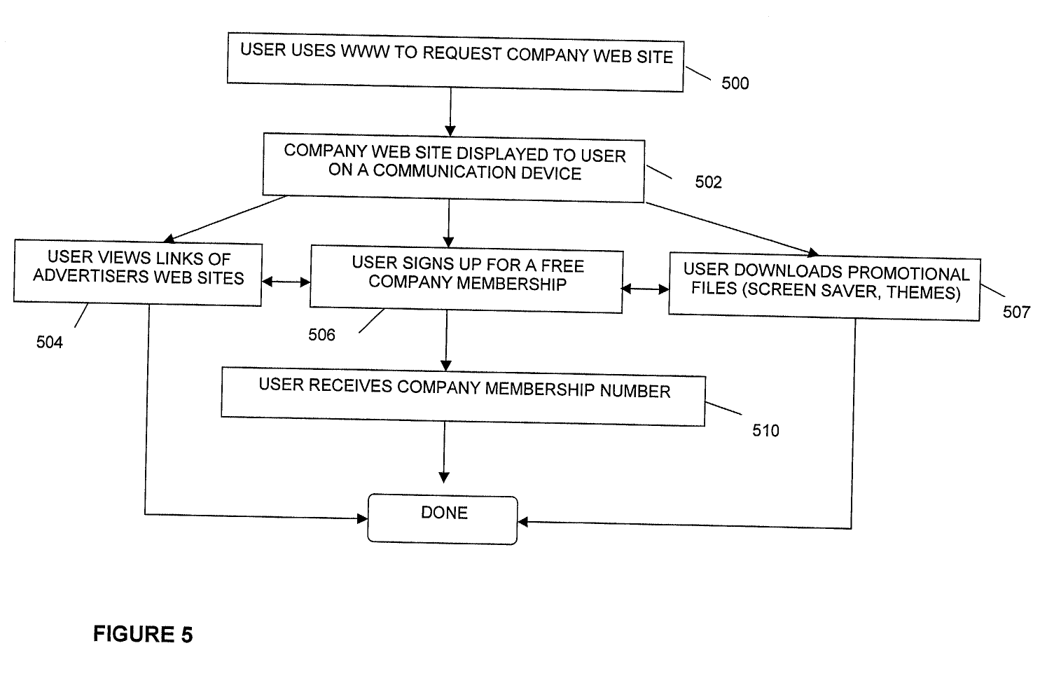

FIG. 5 is a block diagram of an exemplary method of the present invention showing the steps of a user accessing a web site to register for a membership number along with other available options. At step 500, a user uses a web browser on a communication device 204 to access the ASP web site via the World Wide Web (WWW). The ASP web site is displayed to the user on the communication device 204 at step 502.

The ASP web site provides a number of different options, and can be configured and appear in any manner. The ASP web site will preferably allow the user to view links of advertisers' web sites 504, sign up for a free or paid ASP membership 506, and download promotional files 508, including the ability to view the streaming video described above.

The user can view links to advertisers' web sites 504 via a web page, banner advertisements, a search engine, or in any related manner. The information about the advertisers will preferably be placed on a web page and presented to the user in a uniform format. For example, links to advertisers web sites can be organized in a standard group of information fields, including company name, address, phone, city, state, zip code, email, web site address, category, web site description information, media segment host, media segment date or time, media segment channel, or in any other related manner. For example, a user can locate a media segment using one or more information field, then view that particular archived media segment or live media segment.

The user can download promotional files 508 such as screen savers, wallpaper, desktop themes, programs, streaming videos and similar related files. These promotional files provide additional functionality to the user while advertising the company's services or advertiser web sites. The screen saver can have scrolling web sites addresses that move from the top to the bottom and/or slowly move horizontally in a continuous loop. If a user watching the screen saver sees a web site address of interest, he or she can log onto the ASP's web site or go directly to that advertiser's (the client's) web site. The screen saver can be automatically updated or updated when the user accesses the ASP web site. In an example implementation, interactive screen savers and/or wallpaper can be used. A list of web site addresses would be presented to the user in an interactive configuration where the user can select a particular web site address from the interactive screen saver and/or interactive wallpaper. The user would then be taken to the web site associated with that particular web site address. The web site addresses can be presented in any form or manner.

The user can sign up for a free ASP membership 506 by accessing an on-line sign up form for registration. The user can be required to enter contact, billing, or other related information. After the user has filled out and submitted the on-line sign up form, an ASP membership number will appear on the communication device as a web page as in step 510. The user can then use the ASP membership number for special discounted purchases. The membership number will preferably be used to receive special discounted purchase prices on goods or services, and/or receive accumulated credits for free products, advertising, or services. The membership number can be used in any manner and can include any combination of uses.

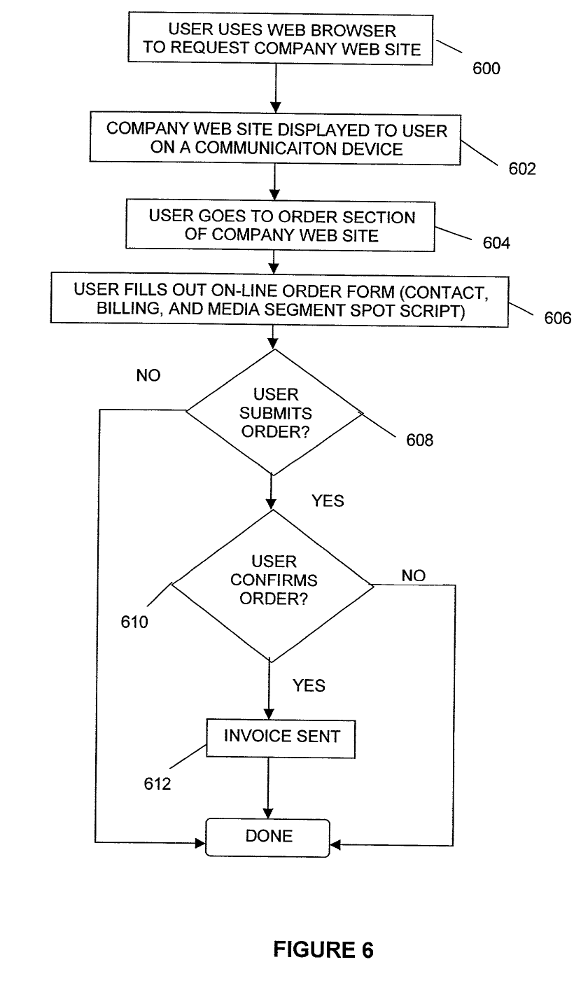

FIG. 6 is a flowchart of an exemplary method of the present invention showing how a user, in this case, a potential advertising client, accesses a web site to place an order for media time. At step 600, a user (client) uses a web browser on a communication device 204 to access the ASP web site via the World Wide Web (WWW). The ASP web site is displayed to the user on the communication device 204 at step 602. The user goes to the order section of the ASP web site 604. At step 606, the user fills out an on-line order form with appropriate sales and billing information including name, address, payment information, media segment spot script, media segment air dates and times, web site address and brief description, and other related information. The media segment spot script is information that the media segment host will incorporate in the promotional pitch about the client's web site.

The user (client) can have the option of paying by the telephone, fax, email, on-line, or by returning their payment with an invoice. Once the client submits the order 608, the he or she will receive a confirming web page that includes all sales and billing information and media segment information, including air dates and times. Emphasis is placed on the media segment spot script or information for creating the media segment spot script to ensure the correct information is used. Once the client has confirmed the order 610, an invoice will be sent 612.

The invoice can contain confirming information including contact information, billing information, media segment spot script (or information), media segment spot air dates and times, banner advertisement rotation, banner advertisement placement, category placement, web site scroll information, and various statistical information regarding the rotation of the web site address scroll and banner advertisement. The invoice can provide for the client to submit payment of the order if the client had not paid at the time of ordering. The invoice can be delivered by traditional mail, facsimile, email, web site, or other appropriate method.

Other embodiments and modifications of the present invention may occur to those of ordinary skill in the art in view of these teachings. Therefore, this invention is to be limited only by the following claims which include all other such embodiments and modifications when viewed in conjunction with the above specification and accompanying drawings.

I claim:

1. A method for advertising Internet web sites to a plurality of communication device viewers, the method comprising:
a) acquiring air time from a media provider, wherein the media provider transmits programming over a communication network for display on a plurality of communication devices;
b) marketing and selling advertising services to a plurality of web site proprietors, each web site proprietor having a web site address;
c) producing a media segment for display on a communication device comprising a combination of two or more advertising formats selected from the group consisting of a list of web site addresses for the plurality of web site proprietors, a video featuring a selected web site proprietor or service or product of the selected web site proprietor; a banner advertisement featuring one or the plurality of web site proprietors; and
d) transmitting the media segment over the communication network during the acquired air time for viewing on display screens of the communication devices.

2. The method of claim 1, wherein the communication device comprises a television and the media provider is selected from the group consisting of cable providers, television stations, and satellite providers.

3. The method of claim 1, wherein the communication device is selected from the group consisting of interactive televisions, non-interactive televisions, computers, mobile phones, video phones, and pagers.

4. The method of claim 1, wherein the communication network is the Internet and wherein the media segment includes a video comprising a streaming video, and further comprising the step of providing a link between the web site proprietor's web site and a separate web site operated by an advertising service provider that provides for accessing and running the streaming video.

5. The method of claim 4, further comprising monitoring the streaming video to count a number of times the streaming video is viewed.

6. The method of claim 5, further comprising charging the web site proprietor a fee according to the number of times the streaming video is viewed.

7. The method of claim 4, further comprising providing a second link to the streaming video at the advertising service provider's web site.

8. The method of claim 1, wherein the communication network is the Internet and each web site address is displayed as a hyperlink to the proprietor's web site.

9. The method of claim 1, wherein one of the selected advertising formats is a list of web site addresses and further comprising scrolling the list on a display screen of the communication device.

10. The method of claim 1, wherein one of the selected advertising formats is a list of web site addresses and further comprising categorizing the web site addresses according to a type of business of the web site proprietor and displaying the web site addresses under a category heading corresponding to the type of business.

11. The method of claim 1, wherein one of the selected advertising formats is a list of web site addresses wherein each web site address has descriptive information associated therewith.

12. The method of claim 1, further comprising formatting the media segment to display each selected advertising format in a distinct segment of each display screen.

13. A method for promoting Internet web sites to a plurality of Internet users, the method comprising:
providing production services for producing a video comprising promotional information for a web site proprietor's product or service;
storing the video as a video file on a streaming server linked to a service provider's web site;
adding a hyperlink at the web site proprietor's web site for linking to the service provider's web site and the streaming server to play the video; and
providing means for counting a number of times the video is played.

14. The method of claim 13, wherein further comprising charging the web site proprietor an advertising fee that is proportional to the number of times the video is played.

15. The method of claim 13, wherein the video comprises an audio/video presentation selected from the group consisting of a promotional pitch, an interview, a testimonial, and a product demonstration.

16. The method of claim 13, further comprising adding a second hyperlink to the service provider's web site for accessing the video, wherein the second hyperlink comprises information identifying the web site proprietor or the web site proprietor's product or service.
